(19) United States
(12) Patent Application Publication
(10) Pub. No.: US 2008/0311551 A1
(43) Pub. Date: Dec. 18, 2008

(54) Testing Scoring System and Method

(75) Inventor: Michael Allen Reed, Xenia, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: MAZER CORPORATION, THE, Dayton, OH (US)

(21) Appl. No.: 12/064,379

(22) PCT Filed: Aug. 23, 2005
(86) PCT No.: PCT/US05/29864

§ 371 Date: Sep. 4, 2008

(51) Int. Cl. G09B 7/00

(52) U.S. Cl. 434/356

(57) ABSTRACT

Systems (FIG. 2) and methods for assessment of constructed responses provided in digital images are disclosed. In particular, what is disclosed are digital scoring systems (FIG. 2) and methods tehreof used in obtaining information from groups of people having the individuals (respondents) fill in pre-printed mark read forms (36) by placing marks in selected boxes on the forms and which are the scanned and analyzed by software utilizing optical mark reading (OMR) and optical/intelligent character recognition (OCR/ICR) routines.

The present invention relates to systems and methods for assessment of constructed responses provided in digital images, and in particular to digital scoring systems and methods thereof used in obtaining information from groups of people by having the individuals (respondents) fill in pre-printed mark read forms by placing marks in selected boxes on the forms and which are then scanned and analyzed by software utilizing optical mark reading (OMR) and optical/intelligent character recognition (OCR/ICR) routines.

Pre-printed mark read forms have been used for many years such as, for example, answer sheets for multiple-choice tests for students. Typically, the pre-printed mark read forms carry alphanumeric characters together with associated boxes in selected ones of which the respondent will insert marks, to indicate a response. A stack of filled in ones of such pre-printed mark read forms can be processed rapidly by optical sensing equipment, such as a scanner. A computer associated with the scanner carries out a program to determine the responses selected by each person and to compile a summary or other analysis of the results.

A scanner classified as an optical mark reader (OMR) is a dedicated scanner which is able to detect the presence of marks that have been filled in using a technology that uses very specifically placed LED's to sense marks in certain columns once a timing track (i.e., hash markings running down along one side of the forms) is detected. This requires very tight registration in the design and printing of these pre-printed mark read forms. If the timing track and the bubbles on such forms are not in the exact columns where the LED's in the read head can detect them, the scanner is unable to read the marks. This is referred to as skew and float. Accordingly, the printing of these forms must be very precise, making the preparation of the pre-printed mark read forms undesirably costly. Another problem with such systems is that too many sheets are rejected during automatic processing due to failure of forms to meet specifications in spite of costly preparation. Printing the mark read forms to tighter tolerances can improve performance, but is still more costly.

Additionally, present systems in use today ordinarily print the boxes of OMR forms in drop-out ink, i.e. ink that is (for the particular scanning beam wavelength) not reflectively (or transmissively) different from the background of the sheet, and that therefore will not be “seen” by the optical scanning beam. In such systems, the boxes are seen visually by the person filling out the form, but the optical scanning apparatus does not “see” the box and simply examines the region of the form where it is instructed to look for a mark. Accordingly, copies of OMR forms are unusable, as they cannot be scanned. This can be costly and frustrating to the end user if additional mark read forms are needed, for instance, as in the case of a shortage in the original OMR forms at a critical time such as during the administering of a test. Production and use of such pre-printed mark read forms complied as a scorable booklet have other problems.

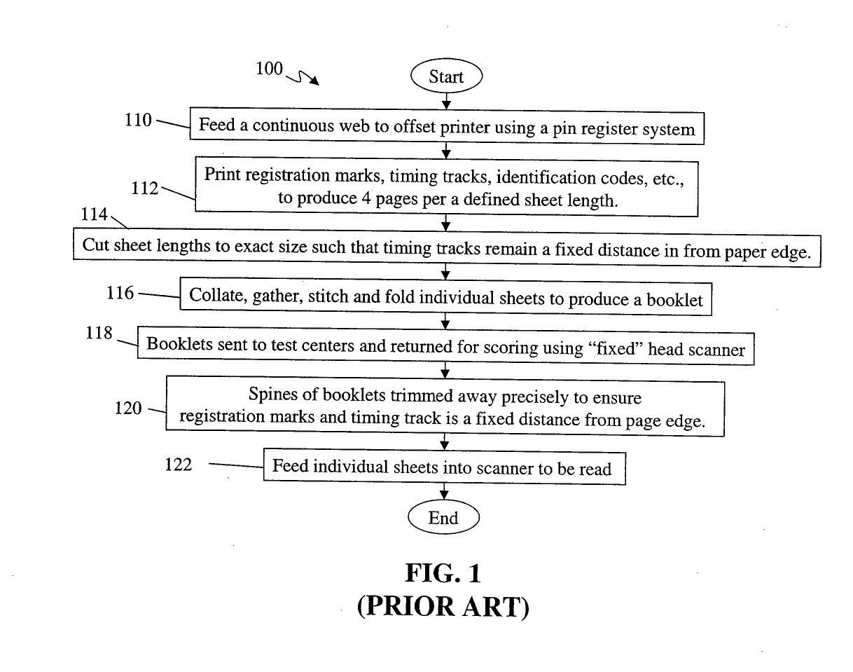

For example and with reference to FIG. 1, a conventional workflow process for creating a scorable booklet of such pre-printed mark read forms, and scanning of the scorable booklet for scoring, is illustrated and indicated generally as symbol 100. In step 110, a continuous web is fed to an offset printer using a pin registration system for tight orientation and positioning control of the printing on the web. In step 112, typically for each predefined sheet length of the web, four pages of print are printed. It is to be appreciated that on each page, number coding, timing tracks, registration marks and other features are provided which are used by a conventional fixed head scanner for the verification and accuracy of the automatic scoring of such forms. With such conventional scanning processes, as page and print registration is critical, printing more than four pages of print per predefined sheet length of web becomes inefficient due to increased registration errors, and thus more costly.

In step 114, the web is cut into lengths such that at least the timing tracks remain a fixed distance in from a thumb's edge of the paper. As mentioned above, the timing tracks must fall within a designated area in order to be scanned properly. For this reason, the distance from the thumb's edge of each page to the timing track must be consistent, which requires the cutting process to be precise, and thus adding additional cost in order to maintain such precision.

In step, 116 the cut lengths are collated, gathered, stitched, and folded into a scorable booklet. After the scorable booklets have been shipped to test centers, such as schools or other data collection centers for testing, balloting or surveying, the filled-in scorable booklets are returned to a scoring center for scoring using the fixed head scanner in step 118. Before scoring, in step 120 the spines of the scorable booklets are trimmed away, which again must be precise to ensure that the registration marks and timing tracks on each page is a fixed distance from the edge of the paper. This is so that the respondent sheet when fed into the scanner in step 122 can be properly read and scored by the OMR scoring software. As such, page positioning requires that the cutting, gathering, stitching, and folding in step 116, and the trimming in step 120 must be exact (plus or minus 1/64″). Maintaining such a tight tolerance is costly and affected greatly by variations in the above processes that often result in the timing track not being in the proper location to be read by the scanner.

It is against that above mentioned background that the present invention provides in one embodiment, form creation and processing software that recognizes optical marks using a scanner classified as a page scanner, flatbed scanner, document scanner, which takes a full image of the sheet being scanned. The software of the present invention instructs the scanner where to look for data based on the vertical and horizontal placement of the optical markings (e.g., bubbles, check boxes, etc.). Accordingly, the printing of this type of form does not require tight registration, as timing tracks are not necessary. Skew and float are automatically addressed digitally by the software, and copies instead of originals may be used with the scanners.

In one embodiment, what is disclosed is a method, performed by a processor-based machine on an input image, for deskewing, cropping, and scoring a digital input image. The method comprises operating the processor-based machine to perform the steps of searching for a pair of grouped pixel objects in the digital input image, and determining a skew angle between coordinate locations of the pair of grouped pixel objects in the input images. The method also includes rotating the digital input image a negative amount of the skew angle, searching for coordinate location of the one mark read field, and comparing the coordinate location of the one mark read field in the digital input image to same coordinate location of a corresponding mark read field in a correct answer digital image read from the memory. The method further includes measuring difference between the one mark read field of the digital input image and the corresponding mark read field of the correct answer digital image to determine whether a mark is in the one mark read field of the digital input image, and providing a result of the measuring.

In another embodiment, what is disclosed is system and method of preparing and reading pre-printed forms carrying written material together with at least one mark read field within which a mark may be entered by a person who processes the document for the purpose of alternatively marking the mark read field or leaving the mark read field free of any mark, and wherein the reading of the form identifies whether the one mark read field has been marked. The method comprises forming the pre-printed form by placing characters on a sheet together with the at least one mark read field for receiving a mark, scanning the pre-printed form with an optical scanner to create a digital input image after the person may have marked the one mark read field, and processing the digital input image with a programmed machine processor having assess to memory. The processing includes searching for a pair of grouped pixel objects in the digital input image, determining a skew angle between coordinate locations of the pair of grouped pixel objects in the input images, and rotating the digital input image a negative amount of the skew angle. The processing also includes searching for coordinate location of the one mark read field, comparing the coordinate location of the one mark read field in the digital input image to same coordinate location of a corresponding mark read field in a correct answer digital image read from the memory, measuring difference between the one mark read field of the digital input image and the corresponding mark read field of the correct answer digital image to determine whether a mark is in the one mark read field of the digital input image, and providing a result of the measuring.

Other objects, aspects and advantages of the invention will in part be pointed out in, and in part apparent from, the following detailed description of the embodiment of the invention, considered together with the accompanying drawings and attachments.

FIG. 1 is a prior art workflow diagram of creating a scorable booklet;

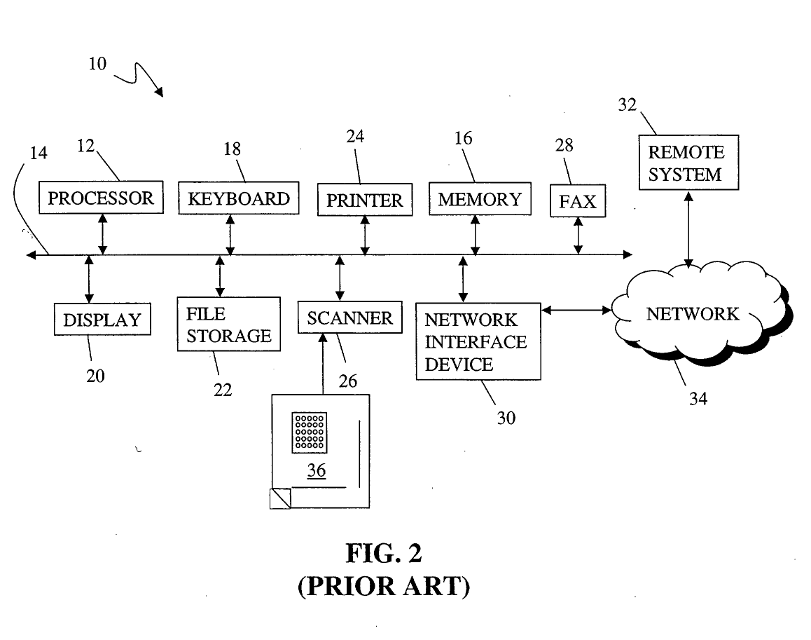

FIG. 2 is a block diagram of a computer system within which the present invention may be embodied;

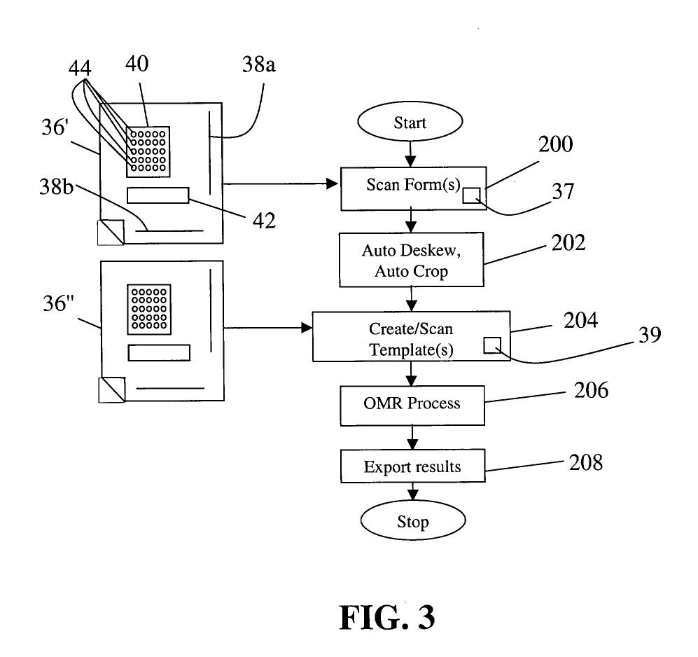

FIG. 3 is a workflow diagram showing a representative sequence of operations for carrying out the present invention;

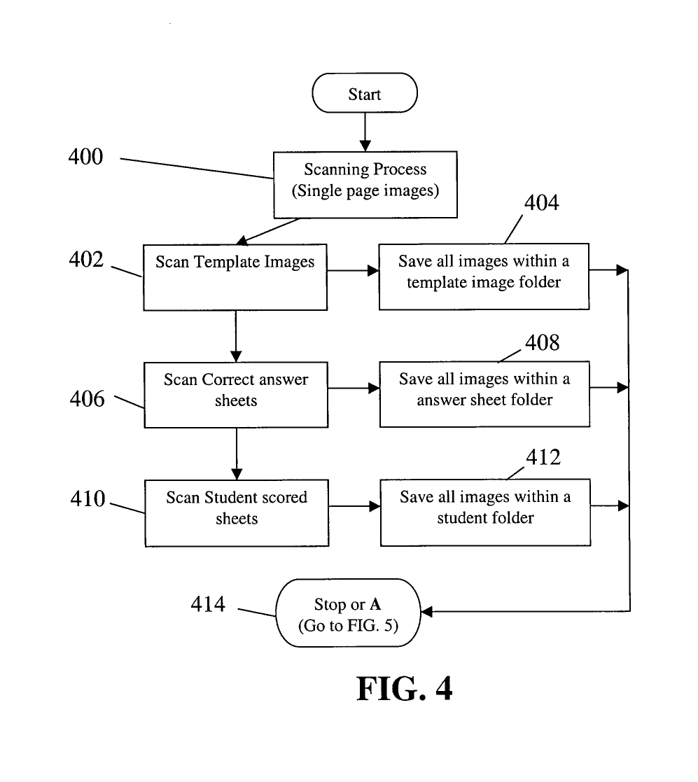

FIG. 4 is a workflow for scanning the forms according to the present invention;

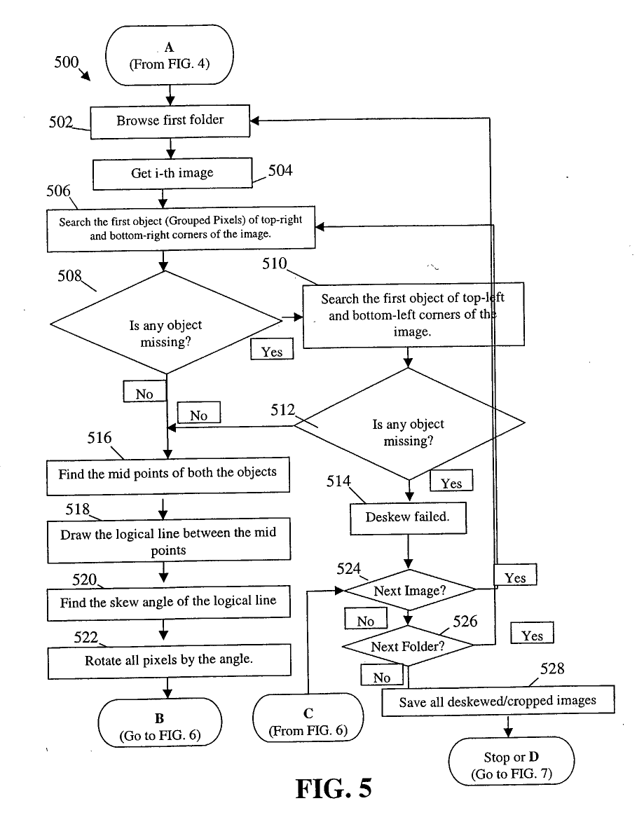

FIG. 5 is a workflow for deskewing the scanned images according to the present invention;

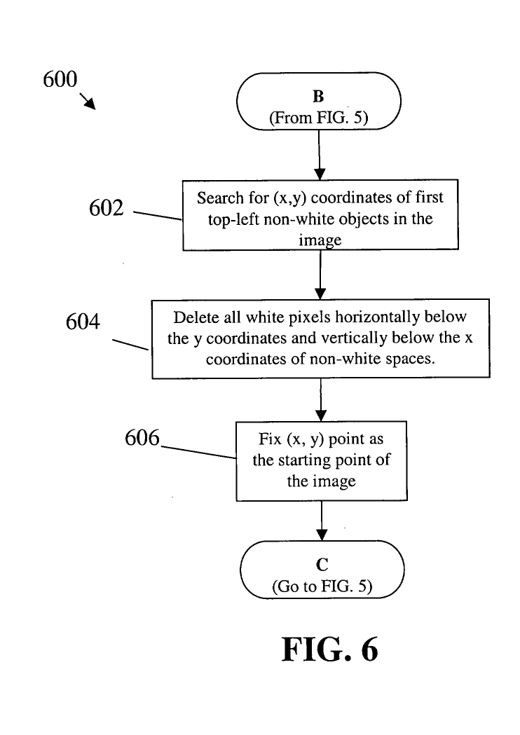

FIG. 6 is a workflow for cropping the deskewed images according to the present invention;

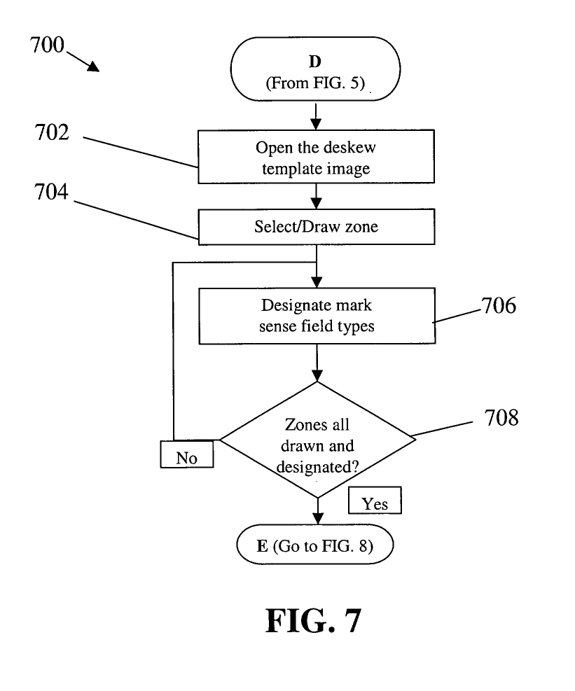

FIG. 7 is a workflow for zoning a deskewed template image according to the present invention;

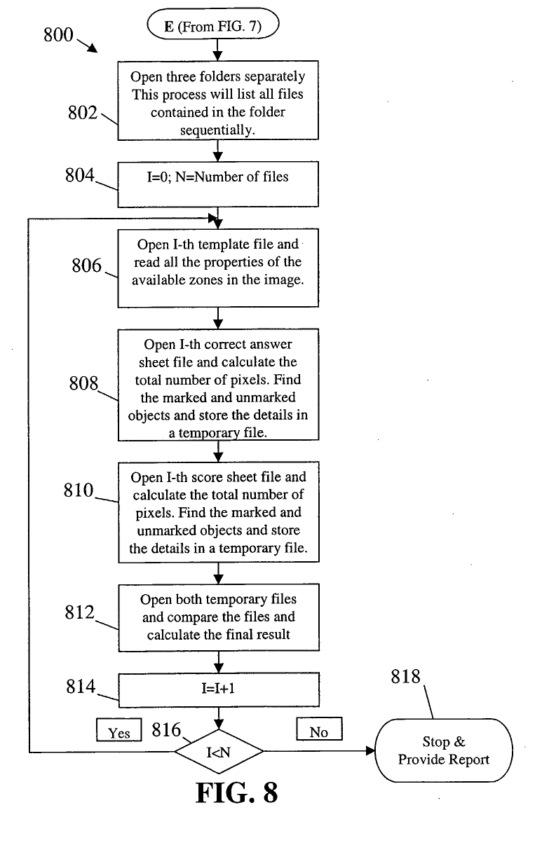

FIG. 8 is a workflow for scoring the deskewed and cropped respondent images according to the present invention;

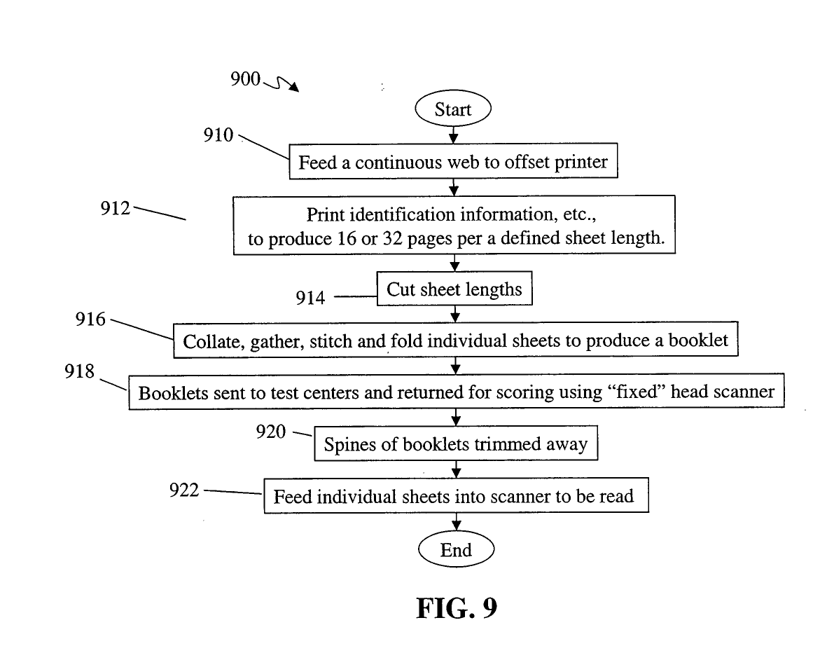

FIG. 9 is a workflow diagram of creating a scorable booklet according to the present invention; and

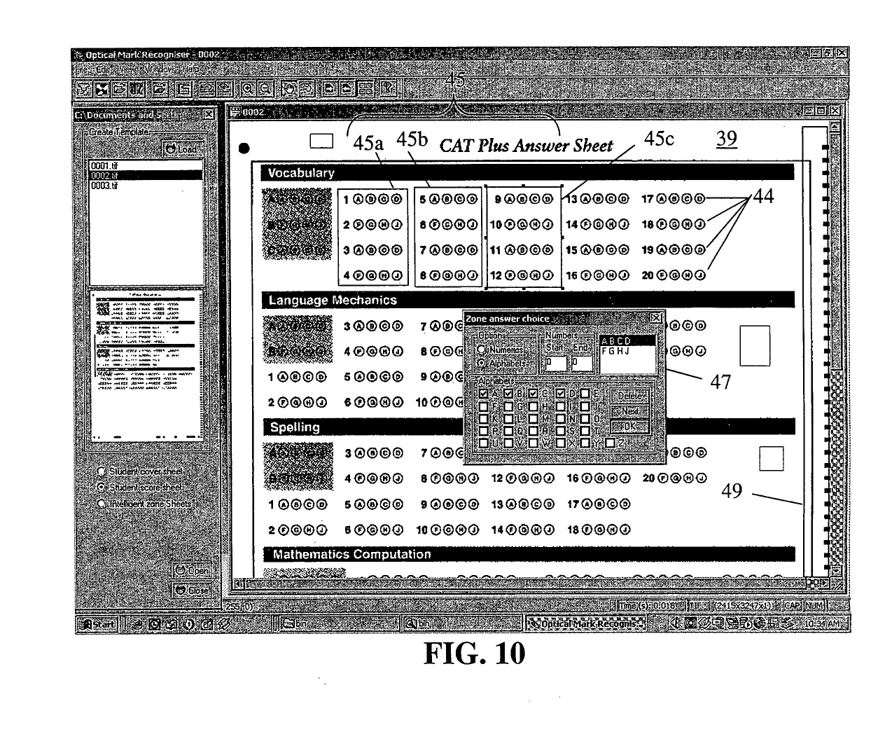

FIG. 10 is a depiction of a graphical user interface according to the present invention used to zone a template and providing a user input box used to designate mark-sense fields in the selected zone.

### SYSTEM OVERVIEW

FIG. 2 is a block diagram of a computer system 10 within which the present invention may be embodied. The computer system configuration illustrated at this high level is conventional, and as such, FIG. 2 is labeled prior art. A computer system such as system 10, suitably programmed to embody the present invention, however, is not. In accordance with known practices, the computer system includes a processor 12 that communicates with a number of peripheral devices via a bus subsystem 14.

These peripheral devices typically include a memory 16, a keyboard or other input device 18, a display 20, a file storage system 22 such as one or more hard disk drives, DVD, CD, tape, and floppy disk drives, a printer 24, a scanner 26, a fax machine 28, and a network interface device 30. The system 10 is in communication with a remote system 32 and a number of others, which may be similarly configured as system 10, via a network 34, which may be public or private, and wired or wireless. It will be appreciated that references to a scanner are generally meant to include a self-contained scanner, a combined printer/scanner/fax machine, and even a network scanner, which may be remote system 32.

The present invention relates to digital image analysis, and according to the invention, processor 12, suitably programmed, operates to extract certain characteristic portions of an input image. In a typical case, the input image originates from a paper document 36 that was scanned into scanner 26 or that was scanned into fax machine 28. The input image may have originated with system 10 or remote system 32 and sent to system 10 over network 34. The file encoding of an input image, the transmission of the encoded file over network, and the file decoding into an output image occur according to standard protocols, such as BITMAP, TIFF, JPG, the CCITT group 3 or group 4 encoding formats, and standard communication protocols, such as TCP/IP, and conversions therebetween. From the point of view of the present invention, what is referred to above as the output image is considered the input image, or any other suitable file format data handling and processing.

### Invention Overview

The present invention is a software based scoring system for any paper based questionnaire, surveys, college enrolment/attendance and school tests, and in fact for any paper based data capture process. The software of the present invention either instructs a scanner 26 that is connected with the system 10 to do a simply image capture scan of a provided filled-in score sheet(s) 36 in a conventional manner, or takes an already scanned image file of the filled-in score sheet(s) from a database 22 or from a remote system 32, and compares it against a template file according to the present invention. The template file can either be created using the software of the present invention or be a properly completed score sheet that is scanned and configured digitally by the software according to the present invention. The present invention scores the filled-in score sheets without the need for tight print registration, or the need for tight folding, cutting, and trimming requirements. The software is able to deskew and crop images automatically, and to compare images to images looking for appropriate matches and mismatches. The software recognizes selected answers, such as for example, tick marks, filled in bubbles, from the scanned digital images of above-mentioned papers and then analyzes the data. The software also complies a summary or other analysis of the comparison results. The results of the analysis are displayed and providing as an exportable scoring result file in a conventional data format. With the system of FIG. 2 in mind, reference is now made to FIG. 3, which is a flow diagram showing a representative sequence of operations for carrying out the present invention.

In step 200, a particular form 36′, which represents a simplified view of a form that might be processed by the invention, is scanned to provide an electronic input image 37. The scanned input image is represented as a two-dimensional data set (rows and columns) of pixels. As can be seen, the form 36′ includes fiducials 38a and 38b, which may take the form of registration marks, timing tracks, form identification numbers, crash numbers, lithographic codes, alphanumeric print, other graphics, and portions thereof, placed adjacent the top right thumb edge and the bottom right thumb edge of the form 36′. Their precise placement of the form, however, is not important as will be explained further hereafter in a later section.

The form 36′ further includes various other fields, designated 40 and 42, that either contain information or accept handwritten information, and a number of mark-sense fields 44. The mark-sense fields 44 allow the user to input information by placing marks in some fields and not others. It is to be appreciated that form 36′ may be a single form, or a plurality of forms, which have been completed by a number of people. It is also to be appreciated that in one embodiment, one of the forms 36′ is a blank form (not filled-in by a person), which is used to create a template as explained hereafter in a later section.

The present invention provides a technique for registering to one of the fields, either to determine if there are marks in it or to extract the content of the field for further use, or both. The description that follows is also directed to determining whether a given mark-sense field contains a mark, but the techniques also apply to extracting other information from the other types. In particular, the software allows the use of a full image scanner utilizing both OCR and OMR software. The system uses targets which are located, and which may or may not by the fiducials 38a and 38b, to not only refer to the exact location of the optical markings (i.e., answer bubbles, check boxes, etc.) but also to insure that a proper scoring template is applied as will be explained hereafter.

Instead of having to locating registration marks and timing tracks precisely on the form 36′, the software of the present invention in step 202, performs an auto deskewing on the input image 37 which orientates the input image to proper registration electronically. Auto cropping is also performed on the input image 37 to remove white spaces to increase scoring speed and accuracy.

In step 204, a template, designated 36″, is scanned or created on the system 10 using the blank form 36′ to provide template image 39. In the embodiment of the template image 39 being generated from a scanned template 36″, the template image 39 would also need to be deskewed and auto cropped. The software of the present invention permits such processing. Accordingly, the template 36″ will be the same as form 36′ except for the mark-sense fields 44 having been filled-in with the desired result. For example, in the embodiment of test scoring, the template is an answer sheet with correct answers by which to evaluate students answer sheets.

In step 206, the software of the present invention performs the reading process to determine the differences between the input image 37 and the corresponding template image 39. Generally, as will be explained in greater detail in a later section, the software of the present invention search for a pair of target locations in the input image 37. Based on the locations (i.e., Cartesian coordinates) of the targets and zoned areas from the template 39, the software determines the coordinate location of the answers, i.e. the locations of the filled-in bubbles and their “x” distance in and “y” distance up or down. The software then compares the read coordinate information from the input image 37 and proceeds to score the input image by comparing it against coordinate information for the correct answers provided on the template image 39. In step 208, the results of the comparison along with optional statistical analysis of the data may be displayed and/or exported in a tabular data fashion. The following sections now describe the concept of the scanning software of the present invention.

### Scan Images

With reference made to FIG. 4, the software uses any scanned images of forms, such as questionnaires, score sheets, or any marked sheets, to capture and recognize the answer types and the respective answers and to evaluate the recognized answers against answers supplied in template images of the same forms. The present invention is not limited in its usage to any specific questionnaires or score sheets. The software has the facility to accept various types of documents, questionnaire and score sheets to produce the results, so long as the template images 39 (FIG. 3) have been designed. As used herein the term “template image” refers to the ‘zoned’ blank questionnaires or score sheets images. Zoned or zoning referred to a selected area of questions and answers that have been identified and to which the software evaluates for markings to questions provided on the input images 37 (FIG. 3). The template zone creation process is explained in a later section with regards to FIG. 7. One illustrative embodiment of a scanning process 400 shown by FIG. 4 is now explained hereafter.

With reference made also to FIG. 2, in step 402, all the blank template forms (e.g., blank answer sheets) are scanned by scanner 26 or fax 28 and in step 404. The resulting scanned template images 39 are then stored in a template image folder provided in file storage 22. Next, in step 406, all the filled-in template forms (e.g., correct answer sheets) are scanned, and then stored in a filled-in template image folder provided in file storage 22 in step 408. The number of template images scanned and the number of scanned filled-in template images should be same. In step 410, all the respondent scored form sheets are scanned and then store them in a scored form sheet folder provided in file storage 22 in step 412. It is to be appreciated that the scanning and saving of the template and scored sheet images should be sequentially.

For example, one embodiment of a file naming convention for the scanned images is blanktemplate$#.tif, answersheet$#.tif, student$#.tif, where $ is a string providing identification of the template, answer sheet, and individual, and # is the number of the form sequentially scanned and numbered. It is to be appreciated that the information for the string $ may be read from the scanned image, such as from a form identification number that is easily read and not dependent on exact registration of the form to the scanner read head, such as a bar code.

After all the images have been saved, in step 414 the scanning process 400 may be stop for later processing or automatically continued to the image processing (i.e., deskewing and cropping) illustrated by FIG. 5. It is to be appreciated that the scanning process may also be conducted on the remote system 32, where the saved image files may be sent via the network 34 to the system 10 for image processing and scoring, if desired. After scanning, the images are then subjected to a deskewing process 500, which is discussed hereafter with reference made to FIG. 5.

### Deskewing

Referring to FIG. 5, the auto deskew process 500 will find a skew angle automatically and then rotates the entire image by that angle. Image skew refers to the rotational error between the dominant orientation of lines of printed objects, such as characters, within a document and an arbitrary reference line observed by a reader or scanner as being zero rotational error. In the present invention, image skew is measured based on grouped pixel objects (i.e., the targets) in the images, which in one embodiment is a group pixel object that forms a rectangle. It is noted that all of the scanned images will have a number of such pixel objects vertically either in the left or right side of the image. In the illustrated embodiment, the deskew process 500 uses Guassian mask values to find the grouped pixel objects in the image. For example, the following is a sample Guassian mask value for a grouped pixel object forming a rectangle target:

$$\begin{matrix}00000000000000000000 \\ 00111111111111111100 \\ 00100000000000000100 \\ 00100000000000000100 \\ 00100000000000000100 \\ 00100000000000000100 \\ 00111111111111111100 \\ 00000000000000000000\end{matrix}$$

Using the above Gaussian mask values, in this illustrated embodiment the software determines the rectangle target with height 3 and width 5 in the image pixels, and moves the height and width of this mask dynamically to find the exact rectangle targets on the image. Matching this mask with each equivalent pixel area by doing XOR operations, the software finds the location of the desired separated grouped pixel objects in the scanned image. In other embodiments, it is to be appreciated that mask of the grouped pixel object may be any geometrical or alphanumerical shape to perform the matching and locating function. If necessary, the software will also re-orientate (e.g., rotate, skew, flip, etc.) the Gaussian mask values to look for the grouped pixel objects. As such, it is not necessary that the scanned images have only rectangular objects, just similar grouped pixel objects.

In step 502, the software will browse each of the folders containing the scanned images and in step 504 read the first sequential image therein. In step 506, the software is programmed to first search for two separated grouped pixel object locations in a pattern that starts at the top right and bottom right corners of the image, and proceeds downwards and upwards, respectively, and then inwards up to half way from the right side of the image. In step 508, the software checks to see whether the two grouped pixel objects were found on the right side of the image. If not, then in step 510, the software repeats the same search pattern but instead from the left side of the image.

The software then checks to see if the two grouped pixel objects had been found in step 512. If not, then the deskewing has failed and the process logs and reports an error message for the image file in step 514. If, however, in either step 508 or 512, the answer is “no”, meaning that the two grouped pixel objects have been located, then after getting the x, y coordinates of the two grouped pixel objects, the software calculates the middle points of both grouped pixel objects in step 516. The software in step 518 then draws a logical line between the two midpoints of the two grouped pixel objects, and computes the skew angle for the logical line from vertical in step 520.

By having the skew angle, then in step 522 all pixels in the entire image is rotated by the negative of the skew angle to deskew the image. After either rotating the image in step 522 and optionally being auto cropped by an auto crop routine 600 illustrated by FIG. 6 (which is explained hereafter), or deskewing failing in step 514, in step 524, the software checks and reads the next image to continue the deskewing and the optional cropping of the images in the current folder. If there is not a next image, then in step 526, the software checks and browses the next folder, and repeats the deskewing and optional cropping processes.

If there is no other folder, then in step 528 all the deskewed and cropped images are saved in a new folder within the folders of their corresponding unprocessed image, such as for example, into a folder named “folderpath\deskewed”, where “folderpath” is the original folder from which the image was read. The process is either stop or continued automatically to a zone creation process 700, which is described in reference to FIG. 7 in a later section hereafter. A discussion of the auto cropping process 600 is now provided with reference made to FIG. 6.

### Auto Crop

The optional auto cropping process 600 depicted by FIG. 6 eliminates large white spaces in each image to improve the speed and accuracy of the scoring process. As mentioned previously above, the electronic image comprises a plurality of binary pixels. That is, each pixel can be considered non-white or white. For example, in an eight bit system with pixel values from 0 (black) to 256 (white), pixels may be defined to be non-white if they are below a preselected threshold value and white if they are above the preselected threshold value. The pixels may further be defined as black if further below another preselected threshold value. In such a system, the threshold values may, for example, be set to predetermined levels or based on a background level determined for the document. The designation of non-white, white and black simply reflects the fact that most documents of interest have a non-white (e.g., black) foreground and a white background. However, it is to be appreciated that the teachings herein are equally applicable to negative images as well.

In step 602, the software searches for the (x, y) coordinates of non-white spaces in the image file using a continuous probability density function, which gives information about the existence of white spaces at various locations in image space. The software starts this process by finding the coordinates of the top-most non-white spaces and works across and down the image. Once all the non-white spaces are located, the software then in step 604 deletes all the white spaces horizontally below the y coordinates and vertically below the x coordinates of the non-white spaces. Next in step 606, the software maps the (x, y) coordinates of the top most non-white space as the starting point of the image file. The process is then return to the deskewing process at step 524 (FIG. 5) for further image processing.

### Zone Creation

Turning now to FIG. 7, a template image zone creation process 700 is shown. The zone creation process 700 permits the software to synchronize the proper fonts of the mark-sense fields 44 of each zone in the template image 39 in order to make an accurate comparison to the student answers in the mark sense fields 44 of the input image 37 (FIGS. 2 and 3). The process starts in step 702 with the user or the software opening a deskewed, and optionally cropped, template image 39 from the template folder. In one embodiment, and with reference also made to FIG. 10, the user box selects the number of the mark-sense fields 44 in a designated zone 45 in step 704, and indicates the number and type of mark-sense fields 44, such as bubbles, squares, check boxes, cross/tick marks, etc., in the zone 45 selected or “zoned” to the software in step 706.

As shown in the illustrated embodiment of FIG. 10, a user input box 47 is provided by the software, which is used by the user to designate the number of type of mark-sense fields 44 in each zone 45. The zones 45 should be box selected and designated in a standard sequential fashion (e.g., top-down left to right). It is to be appreciated that the currently “zoned” mark-sense fields 44 are those with a dimension box (e.g., dimension box 45c) of a first line color there around, and those mark-sense fields 44 already zoned and designated to the software have a box (e.g., boxes 45a, 45b) of a second line color. Accordingly, a user visually knows which mark-sense fields have been zoned. In addition, at any time during this process, the user is free to also delete, draw, and select further zones 45 in the template image 39. The software also provides a masking feature that allows the user to eliminate/mask out areas of an image to eliminate expected differences between the template image and input images. In particular, the user can enable this feature by drawing rectangular boundaries 49 on the areas of the answer template image to be excluded from the image comparison.

In another embodiment, the process of defining the type and number of mark-sense field 44 provided in the selected zones in step 706 is automated by the software, which is then checked for correctness by the user. In this automated process, the software in a routine applied a number of predefined masks in step 706 for object identification. Each mask is a set of two dimensional matrix contains value of combination of 0's, 1's, 240 , and thus can define a number of mark sense field shapes, such as bubbles, squares, check boxes, cross/tick marks, etc. For example, in one illustrated embodiment, the mask for finding bubble type mark-sense fields 44 in the zoned areas on the image is as follows:

$$\begin{matrix}00000000000 \\ 00001110000 \\ 00110201100 \\ 01022222010 \\ 01022222010 \\ 00110201100 \\ 00001110000 \\ 00000000000\end{matrix}$$

It is to be appreciated that the above illustrated matrix size is only provided as a sample size. The software is programmed to change the size of the mask matrix dynamically to fit the actual size of the mark-sense fields in the image. As shown above, the mask is a (11, 7) matrix that contains a collection of 0's, 1's, and 2′s. By matching the mask with each (11, 7) area within the zoned area, it is possible to collect the number of pixels matching. The number of matched pixels is calculated and then compared with a standard threshold value. For example, the threshold value may be 100, which is a standard threshold value for black and white images with standard resolution (300 dpi). If the number of matched pixels is less than a threshold value of 100, which indicates a black or non-white value, the software then stores the coordinates of the compared area on the images.

It is to be appreciated that the pixels within the circle will not be considered as the software is programmed to skip the above-mentioned calculation for every mask value of 2. Accordingly, by moving this process pixel by pixel, the software collects all circle coordinates within the zoned area. In step 708, if not all the desired zones are drawn, the process is repeated, or otherwise stopped in step 710. The software may also automatically proceed to the scoring process 800 illustrated by FIG. 8, after all templates in the template folder have been zoned, if desired. A discussion of the scoring process 800 is now provided hereafter.

Scoring process

Turning to FIG. 8, in step 802, the software opens the three folders containing the deskewed and cropped respondent scored sheet images, template images, and correct answer images. As mentioned above, the images in each folder is listed sequentially. However, it is to be appreciated that the scored sheet folder will list all the respondent scored sheet images sequentially for each individual in a sub-folder. Each individual sub folder contains an equal number of files as with the number of files in the template folder.

In step 804, the counters are initialized, and in step 806, the software reads the first template image and all the properties of the available zones in the template image file. In step 808, the first correct answer sheet image is read and the corresponding coordinate points of the mark-sense fields 44 in the template images, which were determined during the creating of the zones in the template image, are used now to locate the corresponding mark-sense fields 44 in the correct answer sheet. The software then reads the pixel values of each corresponding mark-sense field 44 in the correct answer sheet image and stores these pixel values in a first temporary file. The first temporary file in this manner will contain the correct answers (i.e., matching character pixel values) for each question. In step 810, the software then reads the respondent scored sheet images and performs the same answer locating process as mentioned in step 808. The answers captured from each respondent scored sheet image will be stored in another temporary file.

Finally, in step 812, the two temporary files are opened and compared with one another to determined which answers match or not. For example, if the answers match, the pixel value for the corresponding mark sense field in each temporary file will indicate black (filled-in) if below black's predetermined threshold value, and white (not filled in) if above the white's predetermined threshold value. To resolve slight differences or apply scoring rules, the software in one embodiment may classify the pixel value differences between the two temporary files into classes. The classes could be determined by some previously agreed threshold (based on expert opinion or empirical analysis, etc.) or spatial standard deviation units (showing relative levels of change across the image), wherein answers are recorded which achieve a predetermined threshold of difference between the two images. For example, in the instance of a respondent not filling in a bubble answer completely, the software may use the convention that a difference less than 50% between the numbers of matching pixels is a match. In another instance, where a respondent fills in more than one mark read field were only one answer is required, the software reading two answers would then indicate a non-match. Other such scoring rules and methods conventionally know may be used to make such determinations. All these types of scoring rules may be selectable and thus implemented as desired by the user.

The scoring process will continue for each individual subfolder, as the counter is incremented in step 814, and evaluated in step 816 for completeness. In step 818, the process is stop and the results (e.g., matches, non-matches, total matches, etc.) may be provided to the user with statistical analysis optionally preformed. Such, statically analysis may include, and not limited to, mean, variance, standard deviation, standard error, minimum, maximum, and range determinations. Generated reports can be exported to various formats such as, for example, Microsoft Excel, Microsoft Access, comma-separated files, and any other suitable electronic format.

The present invention also permits the faster production of scorable booklets using an offset web press, and is illustrated and indicated generally as symbol 900 in FIG. 9. In step 910, a continuous web is fed to an offset printer using a conventional feed system. Since the input image and template image are relatively aligned using an x, y coordination system after the deskewing process, tight registration is no longer required. Accordingly, in step 912 the present invention permits the production of scorable booklets using a larger web offset press set up for printing of 16 or 32 pages per length, instead of the lesser efficient and more costly 4 pages per length used by prior art scoring systems using a pin registration system for tighter printing tolerances. As such, the advantages include, and not to be limited to, that an offset press is able to hold dot-to-dot registration to it normally configured plus or minus 0.004″ within a page. Such registration eliminates timing track registration problems and greatly reduces the cost of producing scorable booklets.

In step 914 the lengths are cut, and in step 916 the cut lengths are collated, gathered, stitched, and folded into a scorable booklet. After the scorable booklets have been shipped to test centers, such as schools or other data collection centers for testing, balloting or surveying, the filled-in scorable booklets are returned to a scoring center for scoring using the fixed head scanner in step 918. In step 920 the spines of the scorable booklets are trimmed away, which does not have to be precise, which are then feed into the scanner for scoring by the software according to the present invention. Accordingly, economic cost advantages are provided by being able to produce 4 to 8 times the number of pages in a single pass at press speeds approximately twice as fast, which is an 8 to 32 fold increase in output.

Economic advantageous are also provided by not having to cut and feed booklets into a scanner under tight tolerances. Other advantages the present invention has from using page templates over the prior art pre-printed mark read methods include end user customizable and created forms may be used, standard litho inks can be used instead of drop out inks and carbon less inks only, machined collated, cut, folded, and stitched to equipment provided error tolerances, and any type of marking device instead of No. 2 pencil only, may be used.

While the above is a complete description of the preferred embodiments of the invention, various alternatives and equivalents may be used. Therefore, the above description and illustrations should not be taken as limiting the scope of the invention which is defined by the claims.

1. A method, performed by a processor-based machine on an input image, for deskewing, cropping, and scoring a digital input image, the method comprising operating the processor-based machine to perform the steps of:
searching for a pair of grouped pixel objects in said digital input image;
determining a skew angle between coordinate locations of said pair of grouped pixel objects in the input images;
rotating the digital input image a negative amount of said skew angle;
searching for coordinate location of said one mark read field;
comparing said coordinate location of said one mark read field in said digital input image to same coordinate location of a corresponding mark read field in a correct answer digital image read from said memory;
measuring difference between said one mark read field of said digital input image and said corresponding mark read field of said correct answer digital image to determine whether a mark is in the one mark read field of said digital input image; and
providing a result of said measuring.

2. The method of claim 1, wherein said digital input image is received from a remote source.

3. The method of claim 1 further comprises selecting digitally a zone in a deskewed template digital image, and designating number and type of mark read fields in said digitally selected zone.

4. The method of claim 1 further comprises selecting digitally a zone in a deskewed template digital image, designating number and type of mark read fields in said digitally selected zone, said selecting and designating providing coordinate locations of said zone and said mark read fields therein, and saving in said memory the coordinate locations of said selected zone and mark read fields, and said number and type of mark sense fields therein.

5. The method of claim 1 further comprises deskewing said correct answer digital image before said comparison.

6. The method of claim 1 further comprises deskewing said correct answer digital image before said comparison, selecting digitally a zone in a deskewed template digital image, and designating number and type of mark read fields in said digitally selected zone, said selecting and designating providing coordinate locations of said zone and said mark read fields therein in said template digital image, and locating coordinate locations of corresponding mark-sense fields in said correct answer digital image using said coordinate locations for said zones and mark sense fields of said template digital images.

7. The method of claim 1 further comprises reading pixel values of each corresponding mark-sense field in said correct answer digital image and storing said pixel values in a first temporary file in said memory.

8. The method of claim 1 further comprises reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image.

9. The method of claim 1 further comprises selecting digitally a zone in a deskewed template digital image, designating number and type of mark read fields in said digitally selected zone, said selecting and designating providing coordinate locations of said zone and said mark read fields therein in said template digital image, and locating coordinate locations of corresponding mark-sense fields in said input digital image using said coordinate locations for said zones and mark sense fields of said template digital images.

10. The method of claim 1 further comprising deskewing said correct answer digital image before said comparison, selecting digitally a zone in a deskewed template digital image, designating number and type of mark read fields in said digitally selected zone, said selecting and designating providing coordinate locations of said zone and said mark read fields therein in said template digital image, and locating coordinate locations of corresponding mark-sense fields in said input digital image and said correct answer digital image using said coordinate locations for said zones and mark sense fields of said template digital images, such that corresponding mark sense fields in said input digital image and said correct answer digital image, which have both been deskewed, have the same coordinate locations.

11. The method of claim 1 further comprises deskewing said correct answer digital image before said comparison, selecting digitally a zone in a deskewed template digital image, designating number and type of mark read fields in said digitally selected zone, said selecting and designating providing coordinate locations of said zone and said mark read fields therein in said template digital image, and locating coordinate locations of corresponding mark-sense fields in said input digital image and said correct answer digital image using said coordinate locations for said zones and mark sense fields of said template digital images, such that corresponding mark sense fields in said input digital image and said correct answer digital image, which have both been deskewed, have the same coordinate locations, and wherein said method further comprises reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image.

12. The method of claim 1 further comprises reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, and comparing said temporary files with one another to determined whether a correct mark in a corresponding mark sense field of the correct answer digital image matches said mark if provided in the one mark read field of said digital input image, wherein a match is indicated if the pixel value for the corresponding mark sense field in each temporary file falls within a predetermined threshold value range.

13. The method of claim 1 further comprises reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image, and applying scoring rules to resolve slight differences.

14. The method of claim 1 further comprises reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image, and applying scoring rules to resolve slight differences, said scoring rules handling instances of the person marking more than said one mark sense field, and not completely marking said one mark sense field.

15. The method of claim 1 further comprises cropping said input image and said correct answer digital image to remove white spaces.

16. The method of claim 1 further comprises cropping said input image and said correct answer digital image to remove white spaces using a probability distribution function.

17. The method of claim 1, wherein said providing said result of said measuring includes statistical analysis preformed on said results.

18. The method of claim 1, wherein said providing said result of said measuring includes statistical analysis preformed on said results, said statically analysis includes determining mean, variance, standard deviation, standard error, minimum, maximum, and range from said results, and generating an exportable report thereof.

19. The method of claim 1, wherein said grouped pixel objects is a Gaussian mask.

20. The method of claim 1 further comprises selecting digitally a zone in a deskewed template digital image, designating number and type of mark read fields in said digitally selected zone, wherein said selecting and designating providing coordinate locations of said zone and said mark read fields therein, saving in said memory the coordinate locations of said selected zone and mark read fields and said number and type of mark sense fields therein, wherein said designating the type and number of mark-sense field provided in the selected zones is automated by said processor applying in a routine a number of predefined digital masks of different types of mark sense fields for object identification.

21. A method of preparing and reading pre-printed forms carrying written material together with at least one mark read field within which a mark may be entered by a person who processes the document for the purpose of alternatively marking said mark read field or leaving said mark read field free of any mark, and wherein the reading of the form identifies whether said one mark read field has been marked; said method comprising:
forming the pre-printed form by placing characters on a sheet together with said at least one mark read field for receiving a mark;
scanning the pre-printed form with an optical scanner to create a digital input image after the person may have marked said one mark read field;
processing the digital input image with a programmed machine processor having assess to memory, said processing includes said processor:
searching for a pair of grouped pixel objects in said digital input image;
determining a skew angle between coordinate locations of said pair of grouped pixel objects in the input images;
rotating the digital input image a negative amount of said skew angle;
searching for coordinate location of said one mark read field;
comparing said coordinate location of said one mark read field in said digital input image to same coordinate location of a corresponding mark read field in a correct answer digital image read from said memory;
measuring difference between said one mark read field of said digital input image and said corresponding mark read field of said correct answer digital image to determine whether a mark is in the one mark read field of said digital input image; and
providing a result of said measuring.

22. The method of claim 21, wherein said forming the pre-printing form includes using an offset web press.

23. The method of claim 21, wherein forming said pre-printed form includes printing on a web at least 16 pages per predefined length.

24. The method of claim 21 further comprising providing said pre-printed form in a booklet to the person.

25. The method of claim 21, wherein said scanning is from using a fixed head scanner without precise registration.

26. The method of claim 21, wherein said processing further includes selecting digitally a zone in a deskewed template digital image, and designating number and type of mark read fields in said digitally selected zone.

27. The method of claim 21, wherein said method further includes selecting digitally a zone in a deskewed template digital image, designating number and type of mark read fields in said digitally selected zone, said selecting and designating providing coordinate locations of said zone and said mark read fields therein, and said processing further includes saving in said memory the coordinate locations of said selected zone and mark read fields, and said number and type of mark sense fields therein.

28. The method of claim 21 wherein said processing includes deskewing said correct answer digital image before said comparison.

29. The method of claim 21, wherein said processing includes deskewing said correct answer digital image before said comparison, selecting digitally a zone in a deskewed template digital image, and designating number and type of mark read fields in said digitally selected zone, said selecting and designating providing coordinate locations of said zone and said mark read fields therein in said template digital image, and locating coordinate locations of corresponding mark-sense fields in said correct answer digital image using said coordinate locations for said zones and mark sense fields of said template digital images.

30. The method of claim 21, wherein said processing includes reading pixel values of each corresponding mark-sense field in said correct answer digital image and storing said pixel values in a first temporary file in said memory.

31. The method of claim 21, wherein said processing includes reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image.

32. The method of claim 21, wherein said processing includes selecting digitally a zone in a deskewed template digital image, and designating number and type of mark read fields in said digitally selected zone, said selecting and designating providing coordinate locations of said zone and said mark read fields therein in said template digital image, and locating coordinate locations of corresponding mark-sense fields in said input digital image using said coordinate locations for said zones and mark sense fields of said template digital images.

33. The method of claim 21, wherein said processing includes deskewing said correct answer digital image before said comparison, selecting digitally a zone in a deskewed template digital image, and designating number and type of mark read fields in said digitally selected zone, said selecting and designating providing coordinate locations of said zone and said mark read fields therein in said template digital image, and locating coordinate locations of corresponding mark-sense fields in said input digital image and said correct answer digital image using said coordinate locations for said zones and mark sense fields of said template digital images, such that corresponding mark sense fields in said input digital image and said correct answer digital image, which have both been deskewed, have the same coordinate locations.

34. The method of claim 21, wherein said processing includes deskewing said correct answer digital image before said comparison, selecting digitally a zone in a deskewed template digital image, and designating number and type of mark read fields in said digitally selected zone, said selecting and designating providing coordinate locations of said zone and said mark read fields therein in said template digital image, and locating coordinate locations of corresponding mark-sense fields in said input digital image and said correct answer digital image using said coordinate locations for said zones and mark sense fields of said template digital images, such that corresponding mark sense fields in said input digital image and said correct answer digital image, which have both been deskewed, have the same coordinate locations, and wherein said processing includes reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image.

35. The method of claim 21, wherein said processing includes reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, and comparing said temporary files with one another to determined whether a correct mark in a corresponding mark sense field of the correct answer digital image matches said mark if provided in the one mark read field of said digital input image, wherein a match is indicated if the pixel value for the corresponding mark sense field in each temporary file falls within a predetermined threshold value range.

36. The method of claim 21, wherein said processing includes reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image, and applying scoring rules to resolve slight differences.

37. The method of claim 21, wherein said processing includes reading pixel values of each corresponding mark-sense field in said correct answer digital image, storing said pixel values in a first temporary file in said memory, reading pixel values of said one mark sense field in said input digital image, and storing said pixel values of the input digital image in a second temporary file in said memory, wherein said temporary files are compared with one another to determined whether said mark is in the one mark read field of said digital input image, and applying scoring rules to resolve slight differences, said scoring rules handling instances of the person marking more than said one mark sense field, and not completely marking said one mark sense field.

38. The method of claim 21, wherein said processing further includes cropping said input image and said correct answer digital image to remove white spaces.

39. The method of claim 21, wherein said processing further includes cropping said input image and said correct answer digital image to remove white spaces using a.

40. The method of claim 21, wherein said providing said result of said measuring includes statistical analysis preformed on said results.

41. The method of claim 21, wherein said providing said result of said measuring includes statistical analysis preformed on said results, said statically analysis includes determining mean, variance, standard deviation, standard error, minimum, maximum, and range from said results, and generating an exportable report thereof.

42. The method of claim 21, wherein said grouped pixel objects is a Gaussian mask.

43. The method of claim 21, wherein said processing further includes selecting digitally a zone in a deskewed template digital image, designating number and type of mark read fields in said digitally selected zone, wherein said selecting and designating providing coordinate locations of said zone and said mark read fields therein, said processing further includes saving in said memory the coordinate locations of said selected zone and mark read fields, and said number and type of mark sense fields therein, wherein said designating the type and number of mark-sense field provided in the selected zones is automated by said processor applying in a routine a number of predefined digital masks of different types of mark sense fields for object identification.

44. A system for performing the method of claim 1.

45. A system for performing the method of claim 21.
